(19) United States
(12) Patent Application Publication
(10) Pub. No.: US 2018/0247466 A1
(43) Pub. Date: Aug. 30, 2018

(54) PARKING GUIDANCE SYSTEM

(71) Applicant: HON HAI PRECISION INDUSTRY CO., LTD., New Taipei (TW)

(72) Inventor: YEN-CHUN LIN, New Taipei (TW)

(21) Appl. No.: 15/444,485

(22) Filed: Feb. 28, 2017

(51) Int. Cl. G07B 15/02; G06Q 20/20; G06Q 30/02

(52) U.S. Cl. CPC G07B 15/02; G06Q 30/0284; G06Q 20/203

(57) ABSTRACT

A parking guidance system includes a server, a number of parking POS machines, and a parking display device. The parking display device can be a user's smartphone. The parking POS machine records a parking period corresponding to a parking fee paid and transmits the parking period to the server. According to an electronic map, positions of the parking POS machines are shown together with the parking periods, to inform the user when driving his vehicle by multicolored and marked display as to empty parking spaces available and parking spaces which may soon be vacated and thus available.

### FIELD

The subject matter herein generally relates to parking guidance systems.

### BACKGROUND

When a driver arrives at his destination, finding a parking space to park vehicles such as cars, motorcycles, RV's etc. can be difficult. Parking guidance systems can help improve the parking experience.

### BRIEF DESCRIPTION OF THE DRAWINGS

Implementations of the present disclosure will now be described, by way of example only, with reference to the attached figures.

FIG. 1 is a block diagram schematic diagram of a parking guidance system.

FIG. 2 is a block diagram of an exemplary embodiment of the system of FIG. 1.

FIG. 3 is a block diagram of another exemplary embodiment of the parking guidance system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the s described herein. However, it will be understood by those of ordinary skill in the art that the s described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the s described herein.

A definition that applies throughout this disclosure will now be presented.

The term “comprising” means “including, but not necessarily limited to”; it specifically indicates open-ended inclusion or membership in a so-described combination, group, series, and the like.

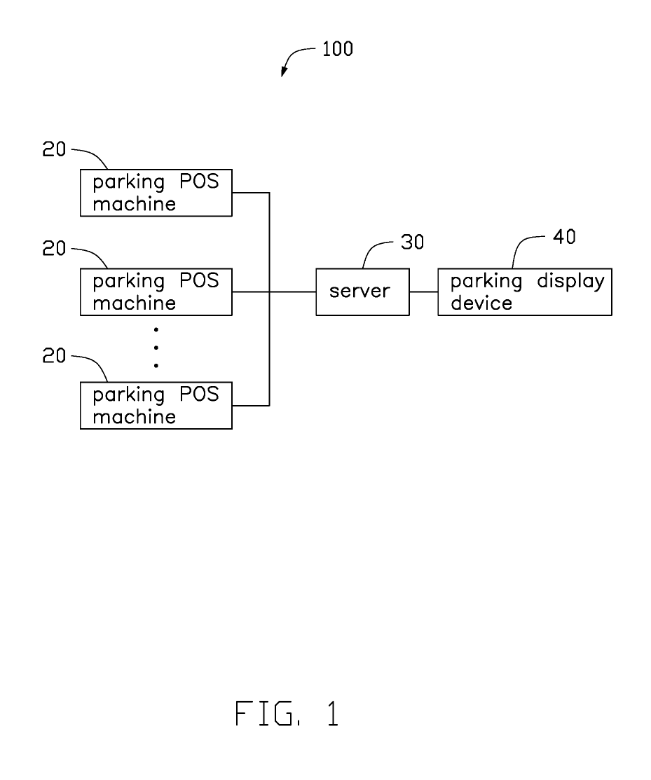

FIG. 1 illustrates an exemplary embodiment of a parking guidance system 100, which includes a number of parking point of sale (POS) machines 20, a server 30, and a parking display device 40. The parking display device 40 and the parking POS machines 20 wirelessly communicate with the server 30. The parking guidance system 100 is configured to assist a driver to find a parking space.

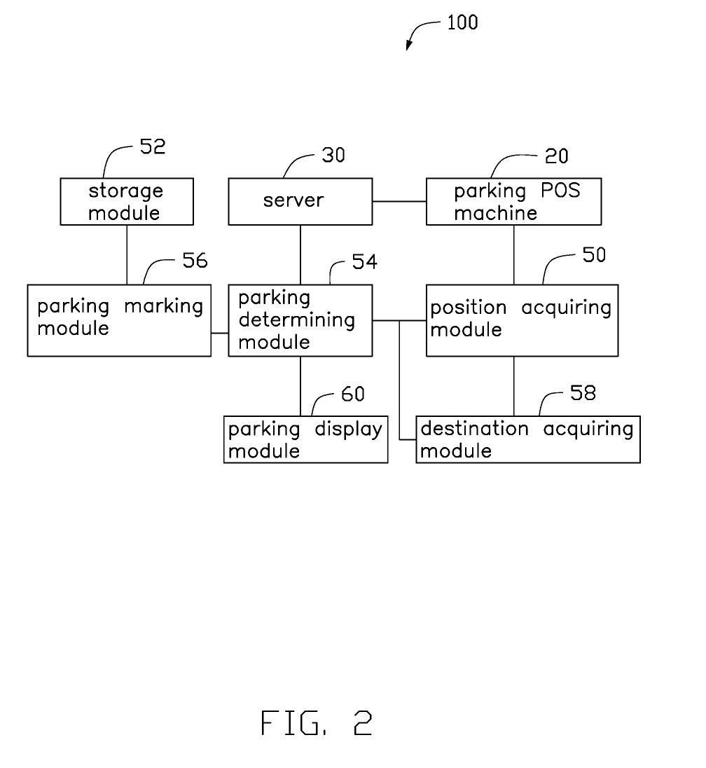

FIG. 2 illustrates a parking guidance system 100. The parking guidance system 100 includes a position acquiring module 50, a storage module 52, a parking determining module 54, a parking marking module 56, a destination acquiring module 58, and a parking display module 60.

The parking POS machine 20 is provided for charging parking fees of vehicles such as cars, motorcycles, RV's etc. The position acquiring module 50 acquires a position of each parking POS machine 20 and transmits the position of the parking POS machine 20 to the server 30. The position acquiring module 50 may be a GPS unit installed in the parking POS machine 20. When the parking fee of the vehicle is paid, the parking POS machine 20 records a parking period corresponding to the parking fee, and transmits the position of the parking POS machine 20 and the parking period to the server 30.

The storage module 52 stores an electronic map relevant to parking. The electronic map includes roads and parking spaces. The parking spaces includes parking space along roadsides. According to the position of the parking POS machine 20, the electronic map, the parking period, and a preset rule, the parking determining module 54 determines a position of a used parking space corresponding to the parking period. The preset rule is that the empty parking space closest the parking POS machine 20 is the used parking space occupied by a vehicle.

A parking marking module 56 marks the used parking space on the electronic map. The used parking space may be marked off as used, such as a gray mark, on the electronic map. The parking marking module 56 further marks the parking period in the used parking space. Thus, the driver knows parking spaces being used and the parking periods of the parking space in use.

The destination acquiring module 58 acquires a destination of the vehicle. The destination acquiring module 58 acquires the destination of the vehicle through a destination selected or input on an electronic map.

The parking display module 60 displays the roads and a state of each parking space within a preset range distanced from the destination of the vehicle on the parking display device 40. The state of the parking space includes whether the parking space is being used. According to the displayed roads and the state of the parking spaces, the driver can select a parking space to park the vehicle.

In an exemplary embodiment, the storage module 52, the parking determining module 54, the parking marking module 56, the destination acquiring module 58, and the parking display module 60 are executed in the parking display device 40. In another exemplary embodiment, the storage module 52, the parking determining module 54, and the parking marking module 56 are executed in the server 30. The destination acquiring module 58 and the parking display module 60 are executed in the parking display device 40. The parking display device 40 can be a user's smart phone.

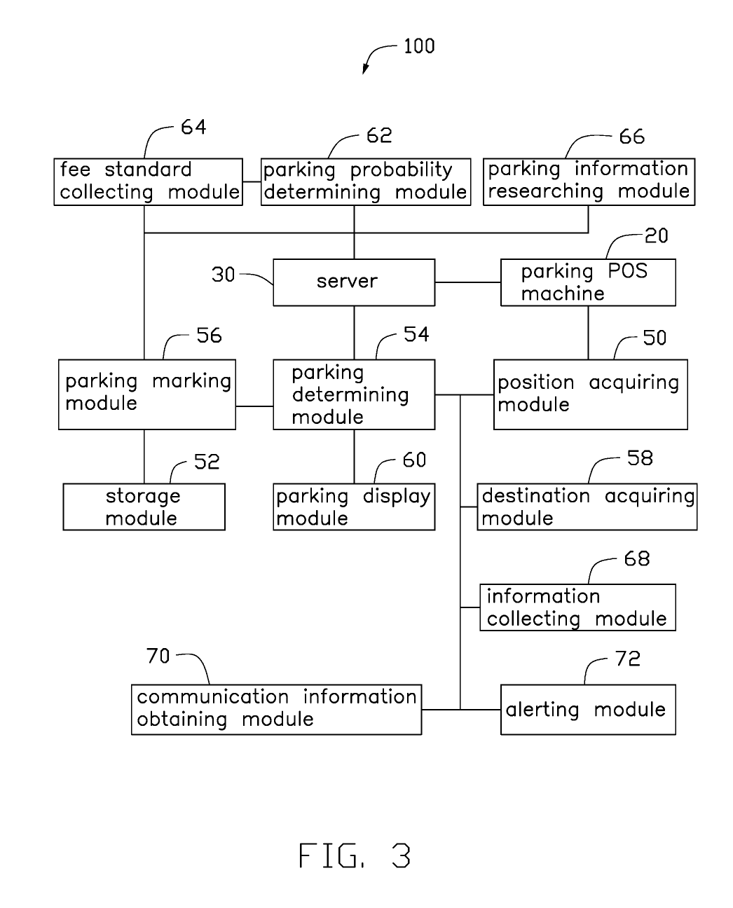

FIG. 3 illustrates another exemplary embodiment of the parking guidance system 100. The parking guidance system 100 further includes a parking probability determining module 62, a fee standard collecting module 64, a parking information researching module 66, an information collecting module 68, a communication information obtaining module 70, and an alerting module 72.

The parking POS machine 20 can further record an identification information of a vehicle and the parking fee of a vehicle. The parking POS machine 20 transmits the identification information and the parking fee to the server 30.

According to the identification information and the parking period of a vehicle, the parking probability determining module 62 determines a parking probability of the parking space at different times. The parking marking module 56 further marks the probability of the parking period in the parking space at certain times. Specifically, when a parking space is used by a same vehicle at a certain time each day, the probability of the parking period at that specific parking space is less or poor at a certain time. When there are more vehicles that can park at a parking space throughout each day, the probability of the parking period at that specific parking space is greater.

For example, during 8:00-10:00, a parking space is always used by a single vehicle. The parking probability determining module 62 determines that the probability of the parking during 8:00-10:00 period is poor. When parking at 8:00 is required, the driver of another vehicle having the system 100 can avoid such a parking space frequently in use when the driver of another vehicle wishes to park at that specific time zone. During the 14:00-16:00 period, a parking space has been used by four different vehicles, each vehicle used the same parking space for half an hour within that period. The parking probability determining module 62 determines that the probability of parking during 14:00-16:00 period is high. When the driver of another vehicle gets close to the parking space at 14:25, the driver can have a better chance to park his vehicle.

According to the parking fee charged for the parking space and the parking period, the fee standard collecting module 64 collects fee standards of the parking space at different times or periods, for example, how much per hour at different times. The parking marking module 56 further marks the fee standard corresponding to the parking space at current or later time. The driver can select parking space according to the fee standard applicable to such parking space. Different parking spaces can have different fee standards at one time. According to the fee standard of each parking space, the parking marking module 56 marks parking spaces with different colors. For example, the parking space having a high fee standard is marked with yellow or red and the parking space having a low fee standard is marked with green. In the exemplary embodiment, the color of the markings is not limited to the examples provided herein.

The parking information researching module 66 provides an interface for inputting the identification information of the vehicle and researches the parking period of the vehicle according to the identification information of the vehicle. Thus, when the driver is shopping for example, according to the parking period of the vehicle, the driver can determine whether to return to the parking space and drive off to avoid paying for the parking space a second time. For example, the driver pays a parking space for his vehicle between 16:00-17:00, and when the time is 16:55, the driver is warned before the expiration time for the parking space.

The information collecting module 68 collects road closure information. The road closure information includes times and dates of road closed and open. The information collecting module 68 can collect the road closure information from a government website about traffic. According to the road closure information and the electronic map for parking, the parking determining module 54 further determines the parking space that is unavailable for parking purposes at any time. The parking marking module 56 marks the parking space on the electronic map corresponding to the disabled parking space with a first disabled parking mark. The parking marking module 56 marks a closed road with a second disabled parking mark. The first disabled mark and the second disabled mark can be red. In the exemplary embodiment, the color of the markings is not limited to the examples provided herein.

The communication information obtaining module 70 obtains information of the driver of the vehicle. The communication information obtaining module 70 can obtain the information of the driver from a vehicle management system. When the vehicle is parked at the parking space within a closed road for a preset period, the alerting module 72 transmits information as to the closed road to the driver of the vehicle. The preset period can be within five days for example before the current date. For example, the vehicle has been regularly parked at a parking space within a road to be closed. The alerting module 72 will transmit information as to the road subject to closure to the driver of the vehicle before the vehicle reaches the road subject to closure, thus the driver can avoid that road during the period of closure.

The embodiments shown and described above are only examples. Even though numerous characteristics and advantages of the present disclosure have been set forth in the foregoing description, together with details of the structure and function of the present disclosure, the disclosure is illustrative only, and changes may be made in the detail, comprising in matters of shape, size, and arrangement of the parts within the principles of the present disclosure, up to the full extent established by the broad general meaning of the terms used in the claims.

What is claimed is:

1. A parking guidance system comprising:
a plurality of parking point of sale (POS) machines for charging parking fees of at least one vehicle;
a server communicating with the parking POS machines;
a position acquiring module configured to acquire a position of each parking POS machine and transmit the position of each parking POS machine to the server;
wherein the parking POS machine configured to record a parking period corresponding to the parking fee and transmit the parking period to the server;
a storage module configured to store an electronic map, wherein the electronic map comprises roads and parking spaces;
a parking determining module configured to, determine a position of a used parking space at a current time according to the position of the parking POS machine, the electronic map, the parking period and a preset rule; wherein the preset rule defines an empty parking space closest to the parking POS machine as the used parking space;
a parking marking module configured to mark the used parking space on the electronic map.

2. The parking guidance system as claimed in claim 1, further comprising:
a parking display device communicating with the server;
a destination acquiring module configured to acquire a destination of the vehicle; and
a parking display module configured to display the roads and the state of each parking space within a preset range distanced from the destination of the vehicle on the parking display device.

3. The parking guidance system as claimed in claim 1, further comprising:
a fee standard collecting module;
wherein the parking POS machine further records the parking fee of the vehicle and transmits the parking fee of the vehicle to the server, according to the parking fee charged for the parking space and the parking period, the fee standard collecting module collects fee standards of the parking space at different periods, the parking marking module further marks the fee standard corresponding to the parking space at the time the vehicle is parked in the parking space.

4. The parking guidance system as claimed in claim 3, wherein different parking spaces have different fee standards at a time; wherein the parking marking module marks parking spaces with different colors according to the fee standard of each parking space at a same period.

5. The parking guidance system as claimed in claim 1, further comprising:
a parking probability determining module;
wherein the parking POS machine further records an identification information of the vehicle and transmits the identification information of the vehicle to the server, the parking probability determining module determines a parking probability of the parking space at different times, the parking marking module further marks the probability of the parking period in the parking space at certain times according to the identification information of the vehicle at the parking space and the parking period of the vehicle.

6. The parking guidance system as claimed in claim 5, further comprising:
a parking information researching module configured to provide an interface for inputting the identification information of the vehicle and research the parking period of the vehicle according to the identification information of the vehicle.

7. The parking guidance system as claimed in claim 1, further comprising:
an information collecting module configured to collect road closure information, wherein the road closure information comprises times and dates of road closed and open.

8. The parking guidance system as claimed in claim 7, wherein according to the road closure information and the electronic map for parking, the parking determining module further determines the parking space for parking purposes at any time.

9. The parking guidance system as claimed in claim 8, wherein the parking marking module further marks the parking space on the electronic map corresponding to the unavailable parking space with a disabled parking mark.

10. The parking guidance system as claimed in claim 8, wherein the parking guidance system further comprises a communication information obtaining module and an alerting module, the communication information obtaining module obtains an information of a driver of the vehicle, when the vehicle is parked at the parking space within a closed road for a preset period, the alerting module transmits information as to the closed road to the driver of the vehicle.

11. A parking guidance system comprising:
a plurality of parking point of sale (POS) machines for charging parking fees of at least one vehicle at roadsides;
a server communicating with the parking POS machines;
a parking display device communicating with the server;
a position acquiring module configured to acquire a position of each parking POS machine and transmit the position of each parking POS machine to the server;
wherein the parking POS machine configured to record a parking period corresponding to the parking fee and transmit the parking period to the server;
a storage module configured to store an electronic map, wherein the electronic map comprises roads and parking spaces along the roadsides;
a parking determining module configured to, determine a position of a used parking space at a current time according to the position of the parking POS machine, the electronic map, the parking period and a preset rule, wherein the preset rule defines an empty parking space closest to the parking POS machine as the used parking space;
a parking marking module configured to mark the used parking space on the electronic map; and
a parking display module configured to display the roads and a state of each parking space along roadsides on the parking display device.

12. The parking guidance system as claimed in claim 11, further comprising:
a destination acquiring module configured to acquire a destination of the vehicle;
wherein the parking display module displays the roads and the state of each parking space along roadsides within a preset range distanced from the destination of the vehicle on the parking display device.

13. The parking guidance system as claimed in claim 11, further comprising:
a fee standard collecting module;
wherein the parking POS machine further records the parking fee of the vehicle and transmits the parking fee of the vehicle to the server, according to the parking fee charged for the parking space and the parking period, the fee standard collecting module collects fee standards of the parking space at different periods, the parking marking module further marks the fee standard corresponding to the parking space at the time the vehicle is parked in the parking space.

14. The parking guidance system as claimed in claim 13, wherein different parking spaces have different fee standards at a time; wherein the parking marking module marks parking spaces with different colors according to the fee standard of each parking space at a same period.

15. The parking guidance system as claimed in claim 11, further comprising:
a parking probability determining module;
wherein the parking POS machine further records an identification information of the vehicle and transmits the identification information of the vehicle to the server, the parking probability determining module determines a parking probability of the parking space at different times, the parking marking module further marks the probability of the parking period in the parking space at certain times according to the identification information of the vehicle at the parking space and the parking period of the vehicle.

16. The parking guidance system as claimed in claim 15, further comprising:
a parking information researching module configured to provide an interface for inputting the identification information of the vehicle and research the parking period of the vehicle according to the identification information of the vehicle.

17. The parking guidance system as claimed in claim 11, further comprising:
an information collecting module configured to collect road closure information, wherein the road closure information comprises times and dates of road closed and open.

18. The parking guidance system as claimed in claim 17, wherein according to the road closure information and the electronic map for parking, the parking determining module further determines the parking space for parking purposes at any time.

19. The parking guidance system as claimed in claim 18, wherein the parking marking module further marks the parking space on the electronic map corresponding to the unavailable parking space with a disabled parking mark.

20. The parking guidance system as claimed in claim 18, wherein the parking guidance system further comprises a communication information obtaining module and an alerting module, the communication information obtaining module obtains an information of a driver of the vehicle, when the vehicle is parked at the parking space within a closed road for a preset period, the alerting module transmits information as to the closed road to the driver of the vehicle.
